(19) United States
(12) Patent Application Publication
(10) Pub. No.: US 2002/0170068 A1
(43) Pub. Date: Nov. 14, 2002

(54) Virtual and condensed television programs

(76) Inventors: Richter A. Rafey, Santa Clara, CA (US); Klaus Hofrichter, Santa Clara, CA (US); Rob Myers, Santa Cruz, CA (US); Sidney Wang, Pleasanton, CA (US); Simon Gibbs, San Jose, CA (US); Hubert Le Van Gong, Santa Clara, CA (US)

Correspondence Address: Intellectual Property Department, Sony Electronics Inc., 123 Tice Boulevard - MD T1-1, Woodcliff Lake, NJ, 07677-8402, US

(21) Appl. No.: 09/812,540

(22) Filed: Mar. 19, 2001

(51) Int. Cl. G06F 3/00; H04N 5/445; G06F 13/00; H04N 7/173

(52) U.S. Cl. 725/112; 725/40; 725/51; 725/109

(57) ABSTRACT

Video content is provided from a video source, and an attribute identifying the subject of a selected segment of the video content is identified. The attribute is coded into a metadata tag that is associated with the selected segment of the video content. The selected video segment and the associated metadata tag are then transmitted or stored for later transmission. At the client end, the selected video content portion and the associated metadata tag are received. A show flow engine uses the attribute information in the metadata tag to create a script that is used by a rendering engine to output video to a viewer. One output format is a compressed version of at least a portion of a long program. Another output format is a “virtual television program” that is assembled using preselected viewer preferences. In some instances the output content of the virtual program is modified by the viewer in real time.

### BACKGROUND

1. Field of invention

The present invention is related to television program production and television program display.

2. Related art

An increasing amount of video information is being produced. For particular viewers, some of that video information is of little interest while other video information is of particular interest. A video program is a block of video material, consisting of many video segments, that encompasses a closed (e.g., self-contained or intended to be consumed by the viewer as a whole) subject matter presentation, such as a feature film, a dramatic episode in a televised drama, or a 30-minute sports “magazine” summary presentation. Viewers presently use devices such as video cassette recorders (VCRs) and commercial video hard disk storage systems to capture and “time shift” video programs that are of particular interest. That is, a machine records a broadcast video program for playback (output) to the viewer at a later time.

Commercial systems exist that instruct the recording machine to record specific programs at known times and from known broadcast channels. Two such commercial systems currently used are the ReplayTV system manufactured by ReplayTV, Inc., of Mountain View, Calif. and the TiVo system manufactured by TiVo, Inc. of Sunnyvale, Calif. These systems typically use one or more transmission channels (e.g., telephone lines), different from the channels used to broadcast video programs, to receive codes that identify the time and broadcast channel of viewer-designated programs. The systems then record the identified programs for later output to the viewer. Thus existing recording systems are capable of operating at a program-level granularity.

Often within each recorded program, however, are segments of video information that are of particular interest to the viewer. Program-level granularity is therefore too coarse for recording only those video content segments that are of special value for the viewer. What is desirable is a system that operates at a fine video content granularity in order to record only those video content segments that are of interest.- In addition, it is desirable for the user to be able to customize the video output to suit the viewer's particular viewing tastes. Such customization would allow the viewer to, for example, vary the selection and presentation order of those special value video segments, and also to specify the amount of time for the presentation of the customized output. It is further desirable to preserve the viewer's expected television viewing environment so that output appears on a typical television in a way similar to a typical television program. Such a viewing environment is unlike current video presentations that are output using personal computers which typically simultaneously show web-browser and other computer-related graphical interface displays.

### SUMMARY

At the video production end, video content is provided from a video source. The video content is routed to a tag generator. At the tag generator, attributes that are associated with selected segments of the video content are identified. The attributes are coded into metadata tags and one unique metadata tag is associated with each unique video segment. The selected video segments and the associated metadata tags are then transmitted to the client end or stored for later transmission.

At the client end, the selected video content segments and the associated metadata tags are received. In some instances both the selected video content portion and the associated metadata tag are automatically stored in local cache. In other instances, a video content manager stores a selected video portion and the associated metadata tag in local cache if one or more attributes in the associated metadata tag correspond to one or more preferences in a viewer preference memory.

A show flow engine, acting together with a rendering engine, outputs video to the viewer in many formats. In some instances the video output format is a new program that includes video segments of particular interest to the viewer that have been culled from one or more broadcast programs. In some instances the viewer modifies this new program format in real time (“on the fly”) to cause additional and more detailed information that is of particular interest to be output, or to cause the output to skip to a subsequent output video segment. In other instances the video output format is a compressed version of at least a portion of a broadcast program, wherein the compressed version shows highlights of the broadcast program.

### BRIEF DESCRIPTION OF THE DRAWINGS

FIG. 1 is a diagrammatic view of an embodiment of a video production system.

FIG. 2 is a diagrammatic view of a video content stream signal that contains video images that have been classified by a tag generator.

FIG. 3 is a diagrammatic view of an embodiment of a video output system.

FIG. 4 is a diagrammatic view that illustrates the creation of a virtual television program.

FIG. 5 is a diagrammatic view of embodiments of video output.

### DETAILED DESCRIPTION

Many conventional video processing components (e.g., converters that create a digital video signal) have been omitted from the figures so as to more clearly show and describe the embodiments. The term “video” is used throughout the specification, but skilled artisans will understand that audio information associated with the video is included in the described and claimed embodiments. Some embodiments include machine-readable instructions (e.g., software, firmware) that are easily coded by skilled programmers in view of the information in this description. Furthermore, the term “content segments” may include video clips, audio clips, web pages, charts, drawings, and the like.

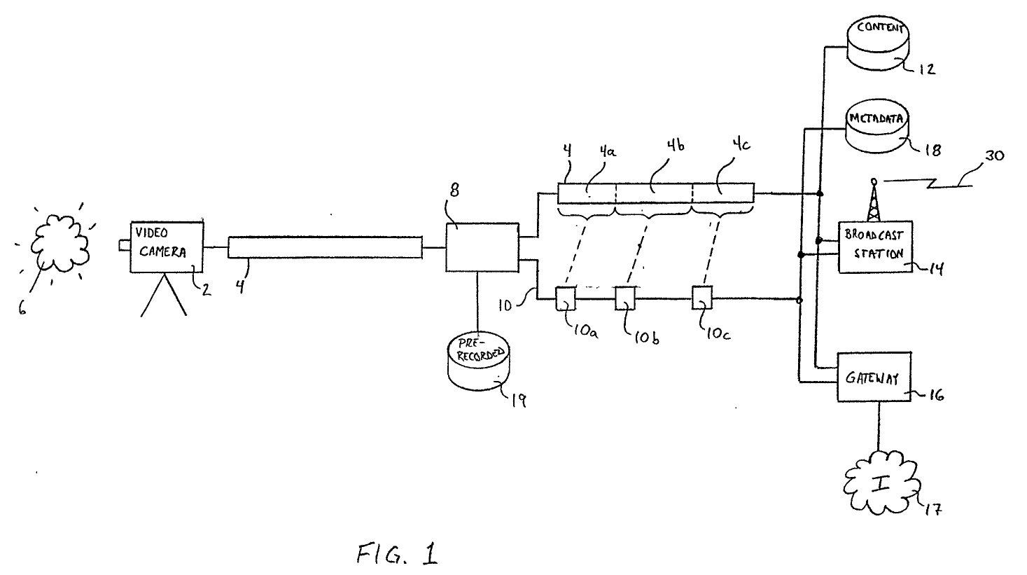

FIG. 1 is a diagrammatic view illustrating the production end of a simplified video system. Video camera 2 (e.g., conventional commercial television camera) produces a signal containing conventional video content stream 4 that includes images of event 6 (e.g., sports event, political news conference, etc.). Video content stream 4 is routed to video tag generator 8. As images in content stream 4 pass through tag generator 8, the content is analyzed and identified, and then segments of the content are classified against predetermined content categories. For example, if event 6 is an automobile race, video content stream 4 contains video images of content segments such as the race start, pit stops, lead changes, and crashes. These content segments are identified and classified in tag generator 8 by, for example, a human operator who is tasked to identify one or more subject matter attributes such as crashes or pit stops. Persons familiar with video production will understand that such a near-real time classification task is analogous to identifying start and stop points in video instant-replays or to recording an athlete's actions by sports statisticians. A particularly useful and desirable attribute of this classification is the fine granularity of the tagged content segment, which in some instances is on the order of one second or less or even a single video frame. Thus a content segment such as segment 4a may contain a very short video clip showing, for example, a single tackle made by a particular football player. Alternatively, the content segment may have a longer duration of several minutes or more.

Once a particular content segment is classified, tag generator 8 creates a metadata (data about data) tag and associates the tag with the particular content segment. The metadata tag contains data that identifies one or more attributes of the content segment. For example, the metadata tag may contain data that indicates that the content segment contains images of a pit stop (one attribute) and the stopping driver's name (a second attribute). Details about metadata tag structure are discussed below. As illustrated in FIG. 1, three unique content segments 4a, 4b, and 4c have been identified in video stream 4. Therefore tag generator 8 has generated metadata signal 10 that includes three unique metadata tags that are associated with the three unique video stream content segments. Tag 10a is associated with segment 4a, tag 10b is associated with segment 4b, and tab 10c is associated with segment 4c. In some embodiments metadata signal 10 is separate from video stream 4, while in other embodiments metadata signal 10 and video stream 4 are multiplexed. Metadata tags may also be assigned to segments of earlier-produced video programs such as documentaries or dramatic productions. For example, video data from a produced program is stored on conventional video storage memory unit 19 that is coupled to tag generator 8. Tag generator 8 is then used to create metadata tags for significant content segments of the program. The metadata tags indicate selected subject matter attributes of the content segments. For example, in some instances tags for a dramatic production identify key portions of the dramatic story line (e.g., the ghost appears to Hamlet). In other instances, tags for documentaries identify segments that contain important background information (e.g., dinosaur eggs first discovered in Mongolia in 1922) that leads to the documentary's conclusion (e.g., the origin of birds).

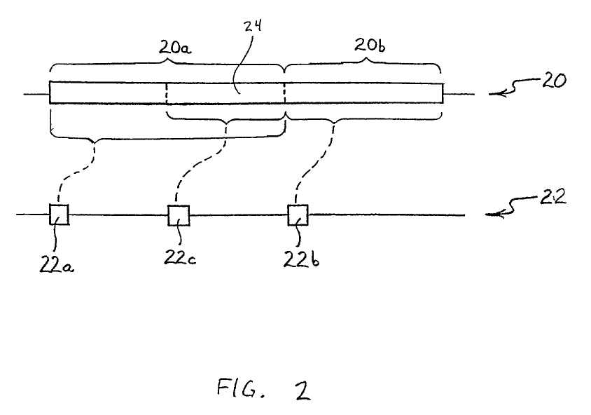

In various embodiments video stream 4 is routed in various ways after tagging. In one instance, the images in video stream 4 are stored in video content database 12. In another instance, video stream 4 is routed to commercial television broadcast station 14 for conventional broadcast. In yet another instance, video stream 4 is routed to conventional Internet gateway 16 for routing using the Internet 17 (network of interconnected networks, having its origin in development under the United States Advanced Research Projects Agency). Similarly, in various embodiments metadata tags in metadata signal 10 are stored in metadata database 18, broadcast using transmitter 14, or routed through Internet gateway 16. These content and metadata routings are illustrative and not limiting. For example, databases 12 and 18 may be combined in a single database, but are shown as separate in FIG. 1 for clarity. Other transmission media (e.g., optical pipe) may be used for transmitting content and/or metadata. Thus metadata may be transmitted at a different time, and via a different transmission medium, than the video content. Metadata tags are layered in some embodiments. FIG. 2 shows video content stream signal 20 that contains video images that have been classified by tag generator 8. Metadata signal 22 contains metadata tags associated with segments and sub-segments of the classified video images. Video stream 20 is classified into two content segments 20a and 20b. Content sub-segment 24 within content segment 20a has also been identified and classified. Thus metadata signal 22 includes metadata tag 22a that is associated with content segment 20a, metadata tag 22b that is associated with content segment 20b, and metadata tag 22c that is associated with content sub-segment 24. The above examples are shown only to illustrate different possible granularity levels of metadata. In one embodiment the use of multiple granularity levels of metadata is utilized to identify a specific portion of the content.

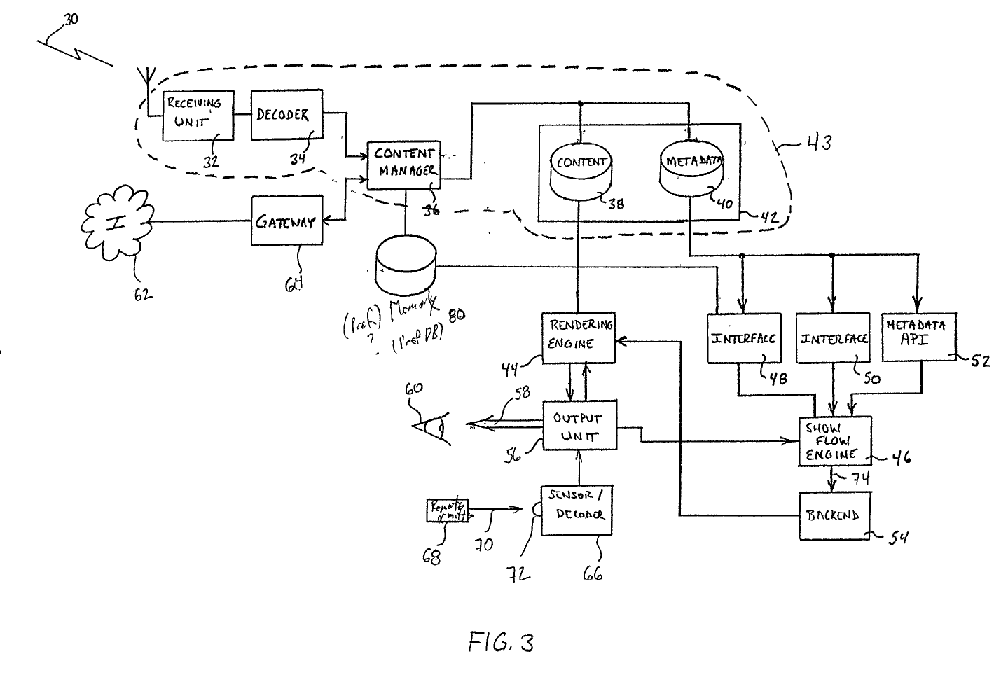

FIG. 3 is a diagrammatic view illustrating an embodiment of video processing and output components at the client end (e.g., viewer residence). Video content, and metadata associated with the video content, are contained in signal 30. Conventional receiving unit 32 captures signal 30 and outputs the captured signal to conventional decoder unit 34 that decodes content and metadata. The decoded video content and metadata from unit 34 are output to content manager 36 that routes the video content to content storage unit 38 and the metadata to metadata storage unit 40. Storage units 38 and 40 are shown separate so as to more clearly describe the invention, but in some embodiments units 38 and 40 are combined as a single local media cache memory unit 42 (e.g., random access audio-visual hard-drive unit). In some embodiments, receiving unit 32, decoder 34, the content manager 36, and cache 42 are included in a single audio-visual tuner/disk combination unit 43. Video content storage unit 38 is coupled to video rendering engine 44. Metadata storage unit 40 is coupled to show flow engine 46 through one or more interfaces such as application software interfaces 48 and 50, and metadata application program interface (API) 52. Show flow engine 46 is coupled to rendering engine 44 through one or more backends 54. Video output unit 56 (e.g., television set) is coupled to rendering engine 44 so that video images stored in storage unit 38 can be output as program 58 to viewer 60. Since in some embodiments output unit 56 is a conventional television, viewer 60's expected television viewing environment is preserved. Preferably, the output unit 56 is capable of being interactive such that the content is able to be selected.

In some embodiments the content and/or metadata to be stored in cache 42 is received from a source other than signal 30. For example, metadata may be received from the Internet 62 through conventional Internet gateway 64. Thus in some embodiments content manager 36 actively accesses content and/or metadata from the Internet and subsequently downloads the accessed material into cache 42.

In some embodiments optional sensor/decoder unit 66 is coupled to rendering engine 44 and/or to show/flow engine 46. In these embodiments viewer 60 uses remote transmitter 68 (e.g., hand-held, battery operated, infrared transmitter similar to conventional television remote control units) to output one or more commands 70 that are received by sensor 72 (e.g., conventional infra-red sensor) on sensor/decoder unit 66. Unit 66 relays the decoded commands 70 to rendering engine 44 or to show flow engine 46 via output unit 56, although in other embodiments unit 66 may relay decoded commands directly. Commands 70 include instructions from the user that control program 58 content, such as skipping certain video clips or accessing additional video clips as described in detail below.

Show flow engine 46 receives metadata that is associated with available stored video content such as content locally stored in cache 42 or that is available through the Internet 58.

Show flow engine 46 then uses the metadata to generate program script output 74 to rendering engine 44. This program script output 74 includes information identifying the memory locations of the video segments associated with the metadata. In some instances show flow engine 46 correlates the metadata with user preferences stored in preferences memory 80 to generate program script output 74. Since show flow engine 46 is not processing video information in real time, show flow engine 46 includes a conventional microprocessor/microcontroller (not shown) such as a Pentium®-class microprocessor. Viewer preferences are described in more detail below.

Rendering engine 44 may operate using one of several languages (e.g., VRML, HTML, MHEG, JavaScript), and so backend 54 provides the necessary interface that allows rendering engine 44 to process the instructions in program script 74. Multiple backends 54 may be used if multiple rendering engines of different languages are used. Upon receipt of program script 74 from show flow engine 46, rendering engine 44 accesses video content from content storage unit 38 or from another source such as the Internet 62 and then outputs the accessed content portions to viewer 60 via output unit 56.

It is not required that all segments of live or prerecorded video be tagged. Only those video segments that have specific, predetermined attributes are tagged. Metadata tag formats are structured in various ways to accommodate the various attributes associated with particular televised live events or prerecorded production shows. The following examples are illustrative, and skilled artisans will understand that many variations exist.

In pseudo-code, a metadata tag may have the following format:

Metadata {

Type
Video ID
Start Time
Duration
Category

Content #1
Content #2

Pointer
}

In this illustrative format, “Metadata” identifies the following information within the following braces as metadata. “Type” identifies the service-specific metadata type (e.g., sports, news, special interest). In addition, different commercial television broadcasters (e.g., commercial television networks) may use different metadata formats for the same type of events (e.g., the American Broadcasting Network (ABC) uses one metadata format for automobile races, and the Columbia Broadcasting Service (CBS) uses another metadata format for automobile races). Thus, using the “type” information, show flow engine 46 identifies the correct application software to use. In another embodiment, the “type” information can indicate whether to process the information at all. “Video ID” uniquely identifies the portion of the video content. The “Start Time” relates to the universal time code which corresponds to the original air time of the content. “Duration” is the time duration of the video content associated with the metadata tag (e.g., frames, seconds). Thus client-end content manager 36 is alerted to the amount of storage space that is required for the associated video content. “Category” identifies a major subject category such as pit stops. “Content #1” and “Content #2” identify additional layered attribute information (e.g., driver name, crashes) within the “Category” classification. “Pointer” is a pointer to a relevant still image that is output to the viewer (e.g., time and frame number after the video segment start point). The still image represents the content of the tagged video portion (e.g., fiery automobile flying through the air for a particularly noteworthy crash). The still image is used in some embodiments as part of the intuitive interface presented on output unit 56 that is described below.

Another metadata embodiment follows a specified format (“schema”) that identifies, for example, the person, the location, and the event in the tagged video clip. Metadata showing President Clinton at Camp David has the format:

<person>President Clinton</person>

<location>Camp David</location>

Metadata showing golf professional Tiger Woods at the British Open has the format:

<person>Tiger Woods</person>

<location>United Kingdom</location>

<event>British Open</event>

Skilled artisans will understand that many schema variations are possible to identify video clip attributes, and those shown are illustrative. A sports-oriented metadata schema may have many detailed and unique attributes while a news-oriented metadata schema may have only a few high-level attributes.

Viewer preferences are stored in preferences database 80. These preferences identify topics (e.g., video clip/metadata attributes) of specific interest to the viewer. In various embodiments the preferences are based on viewer 60's viewing history or habits, direct input by viewer 60, and predetermined or suggested input from outside the client location. To illustrate such preferences as direct input, viewer 60 specifies one or more preferences such as:

(person: Tiger Woods)

(person: President Clinton)

This preference allows show flow engine 46 to identify stored metadata that contains a “Tiger Woods” or “President Clinton” attribute. Show flow engine 46 then uses the metadata associated with the stored content to construct output script 70.

One embodiment is used for situations in which a program output script is generated that incorporates several subject attributes. Weighted ratings are assigned to particular metadata attributes. Using the simplified schema set forth above as an illustrative example, a rating of 10 is assigned to the preferences (person: President Clinton) and (person: Tiger Woods). A rating of 5 is assigned to preference (event: British Open). No other ratings are assigned. Show flow engine 46 then assigns a weight of 10 to the metadata tag for President Clinton at Camp David (one correlation for “President Clinton”). Similarly, show flow engine 46 assigns a weight of 15 to the metadata tag for Tiger Woods at the British Open (correlation for both “Tiger Woods” and “British Open”). Since the Tiger Woods metadata tag has a higher weight, its associated video clip is output prior to the President Clinton video clip. In some embodiments show flow engine 46 includes a metadata decoder (not shown) that assigns the rating values. In other embodiments the metadata decoder (not shown) is encapsulated in a module separate from show flow engine 46, and show flow engine 46 uses this separate module to access the rating values for the metadata.

In some embodiments the metadata is transmitted in tabular form that is similar to a conventional video edit decision list (EDL) that provides a machine-readable start time and duration for each identified portion of the video content. In some Digital Television (DTV) embodiments the metadata is integrated with the content in the broadcast signal. In analog television embodiments the metadata is transmitted, for example, in the vertical blanking interval (VBI) or by another medium, such as the Internet, to provide higher bandwidth than that of the VBI.

Skilled artisans will understand that these simplified metadata examples are presented to more clearly illustrate embodiments, but that complex metadata formats, along with filtering and weighting, that are analogous to these illustrative examples are within the scope of the embodiments.

The fine granularity of tagged video segments and associated metadata allows show flow engine 46 to generate program scripts that are subsequently used by rendering engine 44 to output many possible customized presentations or programs to viewer 60. Illustrative embodiments of such customized presentations or programs are discussed below.

Some embodiments of customized program output 58 are virtual television programs. For example, content video segments from one or more programs that are received by content manager 36 are combined and output to viewer 60 as a new program. These content video segments are accumulated over any practical length of time, in some cases on the order of seconds and in other cases as long as a year or more. Two useful accumulation periods are one day and one week, thereby allowing the viewer to watch a daily or weekly virtual program of particular interest. Further, the content video segments used in the new program can be from programs received on different channels (either by using known methods to sequentially tune and receive unique channels one at a time, or by using known methods to simultaneously receive content on two or more channels). One result of creating such a customized output is that content originally broadcast for one purpose can be combined and output for a different purpose (e.g., content originally broadcast as a sports program can be combined with other content to create an output showing significant events at a particular geographic location). Thus the new program is adapted to viewer 60's personal preferences. The same programs are therefore received at different client locations, but each viewer at each client location sees a unique program that is made of segments of the received programs and is customized to conform with each viewer's particular interests.

Another embodiment of program output 58 is a condensed version (e.g., synopsis, digest, summary) of a conventional program that enables viewer 60 to view highlights of the conventional program. During situations in which viewer 60 tunes to the conventional program after that program has begun, the condensed version is a summary of preceding highlights. This summary allows viewer 60 to catch up with the conventional program already in progress. Such a summary can be used, for example, for live sports events or pre-recorded content such as documentaries. The availability of a summary encourages the viewer to tune and continue watching the conventional program even if the viewer has missed an earlier portion of the program. In other situations, the condensed version is used to provide particular highlights of a completed conventional program without waiting for a commercially produced highlight program (e.g., “sports wrap-up” program). For example, the viewer of a baseball game views a condensed version that shows, for example, game highlights, highlights of a particular player, or highlights from two or more baseball games. Such highlights are in one embodiment selected by viewer 60 using commands from remote transmitter 68 in response to an intuitive menu interface displayed on output unit 56. The displayed menu allows viewer 60 to select among, for example, highlights of a particular game, of a particular player during the game, or of two or more games. In some embodiments the interface includes one or more still frames that are associated with the highlight subject.

In some embodiments the metadata that is used to produce the condensed version is periodically provided by the broadcaster as the program develops, before the program develops, or after the program develops. Either automatically or in response to a command from viewer 60 (e.g., using remote transmitter 68 to issue a “summary” command), show flow engine 46 creates an output script for the condensed version from this periodically provided metadata. In other embodiments the condensed presentation is tailored to an individual viewer's preferences by using the associated metadata tags to filter the desired event portion categories in accordance with the viewer's preferences. The viewer's preferences are stored as a list of filter attributes in preferences memory 80. The content manager compares the attributes in the received metadata tags with the attributes in the filter attribute list. If the received metadata tag attribute matches a filter attribute, the video content segment that is associated with the metadata tag is stored in local cache 42. Using the automobile race example, one viewer may wish to see pit stops and crashes, while another viewer may wish to see only content that is associated with a particular driver throughout the race. As another example, a parental rating is associated with video content portions to ensure that some video segments are not locally recorded.

Yet another embodiment of program output 58 includes additional content that is only appropriate for the new customized output program and that is output in response to viewer 60's real-time request. For example, in some instances short video content (e.g., “video glossary”) is included to supplement the customized program output. In other instances, more lengthy video content is included to provide more extensive information (e.g., “backstories”) about a particular subject in the customized program output. In still other instances, the additional content is originally produced as part of a program but is edited from the program before broadcast (e.g., additional news stories that do not fit in a standard 30-minute news program format). Thus viewer 60 has access to additional produced content that is not available to another viewer watching the conventional program broadcast. The additional content is broadcast in, for example, a DTV video subband or is transmitted via the Internet 62. The availability and selection of such additional content for output to viewer 60 is done using the menu interface on output unit 56.

The capacity to produce virtual or condensed program output also promotes content storage efficiency. If viewer 60's preferences are to see only particular video content segments, then only those particular video content segments are stored in cache 42, thereby increasing storage efficiency and allowing content that is of particular interest to the viewer to be stored in cache 42. The metadata tags enable the local content manager 36 to locally store video content more efficiently since the condensed presentation does not require other segments of the video program to be stored for output to the viewer. Automobile races, for instance, typically contain times when no significant activity occurs. Interesting events such as pit stops, crashes, and lead changes occur only intermittently. Between these interesting events, however, little occurs that is of particular interest to the average race viewer.

In various embodiments the metadata is sent from the service provider to the client location at various times in relation to sending the video content. For some prerecorded programs, the metadata is sent at the beginning of the broadcast and is locally stored. Thus the client-end content manager uses the earlier received and stored metadata to subsequently identify (e.g., filter) and locally store only selected portions of the video content that follows. For other prerecorded programs, the metadata is sent after the video content. The entire video content is locally stored at the client location, and the content manager then uses the metadata to create pointers to the locations in the local storage unit that are associated with content portions. The local content manager then use viewer preference information (filter attribute list) stored in preferences memory 80 to identify locations in the stored content that are not of interest. Additional content that is of particular interest to the user is subsequently stored in these locations. For still other programs, metadata tags that trigger local start and stop recording actions are transmitted concurrently with the video content. The client-end content manager 36 uses the start and stop triggers to record and locally store in cache 42 segments of the received video content identified by the start/stop metadata.

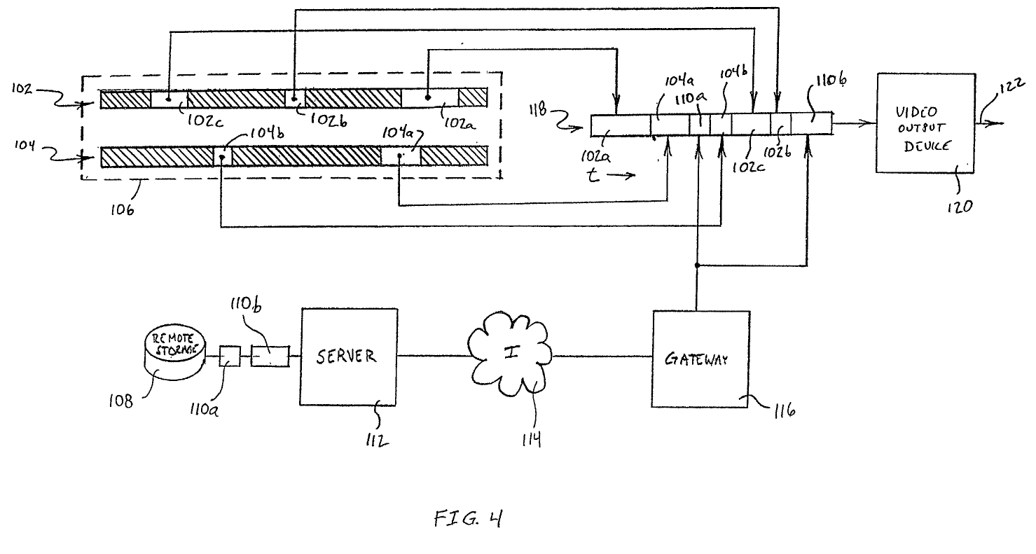

FIG. 4 is a diagrammatic view that illustrates the creation of a virtual television program. As shown in FIG. 4, two video programs 102 and 104 have been stored on video storage memory medium 106. As described above, segments of video programs 102 and 104 have been tagged with metadata tags to identify attributes of the content of each tagged segment. For example, video program 102 is produced by one commercial television service provider (e.g., major television network) and contains video of National Football Conference (NFC) football games. For illustrative purposes, video program 102 includes content segments 102a, 102b, and 102c. Segment 102a contains a commercially produced summary of recent NFC games (“NFC wrap-up”), segment 102b contains video of player Smith, and segment 102c contains video of player Jones. Similarly, video program 104 is produced by another commercial television service provider and contains video of American Football Conference (AFC) games. Video program 104 includes content segments 104a and 104b. For illustrative purposes, segment 104a contains a commercially produced summary of recent AFC games (“AFC wrap-up”) and segment 104b contains video of player Brown.

Storage medium 106 is located in the viewer's residence (locally stored video) as depicted in FIG. 4, but other metadata-tagged video is stored away from the viewer's residence (remotely stored video) using conventional video storage medium 108. Video segment 110a is a custom-produced content segment that introduces viewer 60's preselected preferences (e.g., “This is a custom program for viewer 60 that shows highlights for players Smith, Jones, and Brown”). Video segment 110b is an archived video clip of player Smith. Video stored on medium 108 is retrieved using server 112 (e.g., conventional computer) executing one or more programs that process the information contained in the metadata tags associated with the stored video. The retrieved video segments are routed from server 112 through a conventional communications system 114 such as the Internet to a conventional gateway (e.g., personal computer) 116 in the viewer's residence.

Show flow engine 46 identifies the viewer's video subject preferences, compares the preferences with stored metadata to identify video segments of particular interest to viewer 60, and then uses the metadata tag information associated with various video segments stored at various locations (local and remote) to create the output program script 74 for virtual television program 118. Rendering engine 44 then uses the program script to assemble the video segments and produce virtual program 118. The depicted letter “t” accompanied by the arrow designates time. As shown in FIG. 4, virtual program 118 includes segments 102a, 104a, 110a, 104b, 102c, 102b, and 110b. Program 118 is routed to a video output display device 120 (e.g., a conventional television receiver) for output to the viewer as output 122. Thus in this example, the viewer sees a single program that shows, in order, the NFC wrap-up 102a, the AFC wrap-up 104a, the custom-produced introduction 110a to video segments of the viewer's favorite players, segment 104b of player Brown, segment 102c of player Jones, segment 102b of player Smith, and archived video segment 110b also of player Smith.

Some embodiments enable the viewer to obtain additional video segments in near-real time. For example, in some embodiments video segment 110b is not automatically made part of the virtual television program, but is accessed when the viewer requests more information. That is, the viewer watches portion 102b showing player Smith. The viewer then chooses to view more information using the user interface, and show flow engine 46 matches the metadata associated with segment 102b with metadata for archived video (e.g., same player, same stadium, same opposing team, etc.). Show flow engine 46 then outputs instructions to rendering engine 44 to add to program 118 the archived video portions that have metadata tag attributes that are close matches to the tag attributes associated with segment 102b.

Some embodiments include the capability to allow the view to skip one or more of the program portions that are output using a conventional user interface such as a hand-held remote control. For example, the viewer may choose to skip archive video portion 110b, in which case portion 104b begins to be output. Additional description of adding more content is included below.

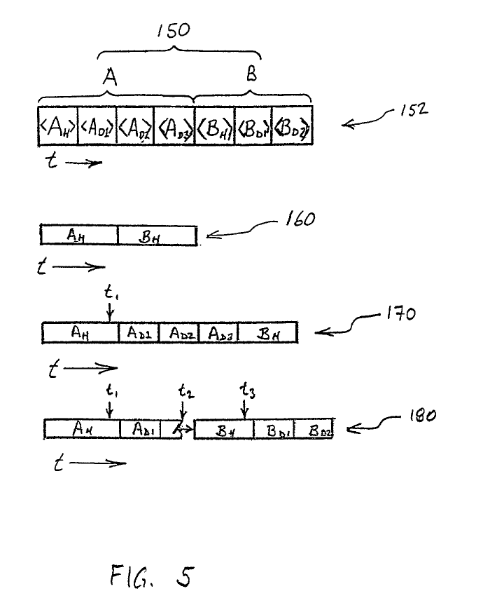

FIG. 5 illustrates embodiments in which an output program is customized in near real time by the viewer. The depicted letter “t” accompanied by an arrow symbolizes time. The embodiments discussed are made simple for clear illustration, but skilled artisans will appreciate that many complex variations are possible. Script 150 is an illustrative output script 74 from show flow engine 46 that includes sequential instructions (symbolized by enclosing carets <>) for two video output subject portions A and B. That is, A is a sequence of instructions to produce an output on a first subject to the viewer and B is a sequence of instructions to produce an output on a second subject to the viewer. Portions A and B are further divided into subject subportions. Portion A includes subject highlight AH and three subject details A_{D1}, A_{D2}, and A_{D3}. Similarly, portion B includes subject highlight B_{H} and two subject details B_{D1} and B_{D2}.

Output 160 is an illustrative program output 58 to the viewer that includes only the highlight video segments that are associated with subportions A_{H} and B_{H} of subject portions A and B. Rendering engine 44 receives output script 152, identifies the instructions for subject highlights A_{H} and B_{H}, accesses the associated video segments for A_{H} and B_{H} from content storage unit 38, and sequentially outputs the accessed video segments to viewer 60. Thus output 160 is illustrative of a condensed program output. By outputting only these highlights, the synopsis/digest/summary or condensed version of the more complete program is output to viewer 60.

Output 170 is another illustrative program output 58 to the viewer that includes both highlight and detail video segments that are associated with subportions of subject portions A and B. Rendering engine 44 receives output script 152, identifies the instructions for all subject subportions, accesses the video segment associated with highlight portion A_{H} from content database 38, and begins to output the accessed video segment to the viewer. At time t₁, which is before the time at which the video segment associated with highlight subportion A_{H} ends, viewer 60 activates remote transmitter 68 that subsequently sends coded instructions 70 that are received by sensor 72 on sensor/decoder 66. In this embodiment, coded instructions 70 are coded to signify that viewer 60 wants additional (“more”) information. This viewer command to output more information is decoded and relayed from sensor/decoder 66 to rendering engine 44 which recognizes that the video segment associated with highlight subportion A_{H} is currently being output and that a command for “more” information has been received. Thus upon receiving the “more” information command, rendering engine 44 accesses from content database 38, in accordance with script 152, video segments that are associated with detail subportions A_{D1}, A_{D2}, and A_{D3}. Once access of the video clips associated with detail subportions A_{D1}, A_{D2}, and A_{D3} begins, the accessed video clips of the detail subportions are sequentially output to the viewer. After the final video segment associated with the detail subportions is output, rendering engine outputs the video segment associated with the highlight subportion B_{H}. In some embodiments a unique video trailer (not shown) is associated with each unique video segment and is inserted at the beginning of each video segment to introduce the segment.

Output 180 is yet another illustrative program output 58 to the viewer that includes both highlight and detail subportions of subject portions A and B. As discussed above, rendering engine 44 receives output script 152, identifies the instructions for all subject subportions, accesses the video segment associated with highlight portion AH from content memory 38, and begins to output the accessed video segment to the viewer. At time t₁, viewer 60 issues a “more” information command and rendering engine 44 begins to output video segments associated with detail portions A_{D1}, A_{D2}, and A_{D3} as discussed above. At time t₂, however, illustrated in this embodiment as part way through the output of the video clip associated with detail subportion A_{D2}, viewer 60 activates remote transmitter 68 that subsequently sends other coded instructions 70 to sensor/decoder 66. These other coded instructions command rendering engine 44 to terminate output of the video segment currently being output as part of program output 58, and then “skip” to a subsequent video segment in output script 152, in this case the segment associated with highlight subportion B_{H}. Rendering engine 44 then outputs the video segment associated with subject subportion B_{H}. At subsequent time t₃, viewer 60 again uses remote transmitter 68 to issue a “more” command to rendering engine 44, which in response accesses and outputs video segments associated with detail subportions B_{D1} and B_{D2}.

In one embodiment, the invention as described above is paid for by a viewer on a subscription basis. The viewer pays the service provider on a periodic basis in exchange for the features of the invention as described above.

The invention has been described in terms of specific embodiments. Persons skilled in the art will appreciate, however, that many variations exist. The invention is therefore limited only by the following claims.

We claim:

1. A method of outputting a television program to a viewer, comprising:
receiving a highlight content segment, wherein the highlight content segment includes information associated with a particular subject;
receiving a detail content segment, wherein the detail content segment includes additional information associated with the particular subject;
storing in a memory the highlight and detail content segments;
generating an output script that is associated with the highlight and detail content segments;
accessing and outputting the highlight content segment in accordance with the script; and
receiving during the output of the highlight content segment a command to output additional information associated with the particular subject; and
accessing and outputting the detail content segment in response to the command.

2. The method of claim 1 further comprising displaying to the viewer a menu that alerts the viewer that the command can be received.

3. The method of claim 1 wherein the script sequences the highlight segment for output prior to the detail segment.

4. The method of claim 1 further comprising:
receiving during the output of the detail content segment a second command to skip to a subsequent content segment associated with the output script; and
accessing and outputting the subsequent content segment in response to the second command.

5. The method of claim 1 wherein the content is one of a video segment, a music segment, a still drawing, a chart, and a web page.

6. The method of claim 1 further comprising receiving a payment for outputting the television program.

7. A method of presenting a television program to a viewer, comprising:
storing in a memory a viewer preference, wherein the preference identifies a subject of particular interest to a viewer;
receiving and storing in the memory a plurality of content segments and a plurality of metadata tags, wherein for each unique one of the content segments a unique one of the metadata tags is associated, and wherein each metadata tag includes at least one attribute that identifies a subject of the associated content segment;
identifying the metadata tags that include attributes corresponding to the preference;
using the identified metadata tags to generate an output program script;
accessing selected stored video segments in accordance with the output script; and
displaying the accessed content segments.

8. The method of claim 7 wherein the attribute is one of a time, a date, a title, a director, and an event.

9. The method of claim 7 wherein the received content segments are part of at least one television program.

10. The method of claim 7 wherein the received and stored content segments are accumulated over a period of time.

11. The method of claim 7 wherein the content segments are one of the following: a video portion, an audio portion, a still drawing, a chart, and a web page.

12. The method of claim 7 wherein receiving and storing in the plurality of content segments and a plurality of metadata tags occurs in a secondary memory device.

13. A method of outputting selected portions of a television program to a viewer, comprising:
receiving at least a portion of a television program that includes a plurality of video segments, wherein each of a selected number of the video segments is associated with a unique highlight of the program;
storing the selected number of video segments;
receiving metadata tags, wherein for each unique one of the selected video segments a unique one of the metadata tags is associated, and wherein each metadata tag includes an attribute that identifies a subject of the associated video segment as a highlight of the program;
storing data associated with the metadata tags;
using the stored data to generate an output program script for outputting the selected number of video segments to the viewer;
accessing the selected number of video segments in accordance with the script; and
outputting the accessed video segments to the viewer.

14. The method of claim 13 wherein the metadata tags are periodically received during reception of the program.

15. The method of claim 13 wherein the metadata tags are received after reception of the program.

16. The method of claim 13 wherein the metadata tags are received before reception of the program.

17. The method of claim 13 further comprising receiving a command from the viewer to output highlights of the television program, and the accessing and outputting of the selected number of video segments occurs in response to the received command.

18. The method of claim 13 wherein the command is received during broadcast of the program, and the selected number of video segments that are output are associated with only a portion of the program already broadcast.

19. A method of storing video information, comprising:
storing in a memory a viewer preference, wherein the preference identifies a subject of particular interest to a viewer;
receiving a content segment of a program that includes a plurality of segments, and receiving a metadata tag associated with the content segment, wherein the metadata tag includes an attribute associated with a subject matter of the content segment;
comparing the attribute and the preference; and
storing in a second memory the content segment if the attribute corresponds to the preference.

20. A video output system comprising:
a receiving unit;
a content manager coupled to the receiving unit;
a video cache memory coupled to the content manager,
wherein the cache memory includes a content memory portion and a metadata memory portion;
a show flow engine coupled to the cache memory; and
a rendering engine coupled to the show flow engine.

21. The system of claim 20 further comprising a sensor/decoder unit coupled to the rendering engine, wherein the sensor/decoder unit receives coded signals from a transmitter activated by a viewer.

22. The system of claim 20 further comprising a viewer preference memory coupled to the content manager and to the show flow engine.

23. The system of claim 20 further comprising a gateway to a communications system coupled to the content manager.

24. The system of claim 20 wherein the communications system is the Internet.

25. The system of claim 20 wherein the receiving unit and the cache memory are parts of an audio-video tuner/disk combination.
